(19) United States
(12) Patent Application Publication
(10) Pub. No.: US 2010/0281509 A1
(43) Pub. Date: Nov. 4, 2010

(54) Prefix caching assisted quality of service aware peer-to-peer video on-demand

(75) Inventors: Shengchao Yu, North Brunswick, NJ (US); Yang Guo, Plainsboro, NJ (US); Saurabh Mathur, Monmouth Junction, NJ (US); Kumar Ramaswamy, Princeton, NJ (US)

Correspondence Address: Robert D. Shedd, Patent Operations;THOMSON Licensing LLC, P.O. Box 5312, Princeton, NJ, 08543-5312, US

(73) Assignee: Thomson Licensing

(21) Appl. No.: 12/448,766

(22) PCT Filed: Jan. 18, 2007
(86) PCT No.: PCT/US2007/001441

§ 371 Date: Jul. 7, 2009

(51) Int. Cl. H04N 7/173

(52) U.S. Cl. 725/100

(57) ABSTRACT

A multimedia-on-demand peer-to-peer device acting as a receiving peer includes a local cache memory device adapted to store a multimedia prefix. Local storage of the multimedia prefix allows rapid commencement of playback of the requested multimedia program without substantially loading the streaming capacity of an associated server device. The storage of multimedia prefixes in local cache memory of the receiving peer device can take place during periods of relatively low network loading so as to optimize network and server scheduling. Included is a method and apparatus for performing admission control in a peer-to-peer multimedia-on-demand system. The admission control system determines if there is sufficient system capacity to support a new request from a peer-to-peer device acting as a client in light of the presence of stored multimedia prefixes at the peer-to-peer device acting as a receiving peer device, among other factors.

### FIELD OF THE INVENTION

The present invention relates to peer-to-peer networking and, in particular, to prefix caching for video-on-demand (VoD) services.

### BACKGROUND OF THE INVENTION

Traditionally, digital video has been provided using a streaming client-server model. When a client request for admission is received at a server the server ascertains whether it has enough resources to serve the client's request and whether there is enough bandwidth along the path between the server and the client to allow acceptable communication of the requested video. If so, the server streams video content to the client.

Due to the limited computation and storage resources at the server and limited bandwidth in the network connecting the server and clients, the scalability of client-server streaming service is limited. Peer-to-peer techniques have been used to improve performance in comparison to purely streaming service.

In a peer-to-peer service, peer devices are implemented with both client style and server style capabilities. This allows a receiving peer to receive content from a serving peer device, with the serving peer device acting as a server device. It is understood that, at any given time a peer device may act as a receiving peer and/or a serving peer depending on the current requirements of the system. This is possible under circumstances where the serving peer has the requisite video data and I/O capability, and where sufficient network bandwidth is available between the serving peer and the receiving peer. Thus Quality of Service aware peer-to-peer video-on-demand service improves system capacity by taking advantage of serving peer's uplink bandwidth while offering viewing quality comparable to that available from the traditional client-server service model. Meanwhile, the server remains available to service urgent data requirements.

As described in a related application, one urgent data requirement serviced by the server is the need to stream a leading sub clip of the video program data for immediate playback at the receiving peer. This reduces a delay to the beginning of presentation that the receiving peer would otherwise experience after admission. The streaming of leading sub clips can represent a significant load on the server, and may adversely affect system scalability. Indeed, the server may become saturated quickly as the rate of requests for admission increases. Consequently additional receiving peer devices cannot be accommodated.

In peer-to-peer live streaming, it is difficult to minimize start-up delay without sacrificing system scalability. In peer-to-peer video-on-demand service, allowing asynchronous users to share video data without undue startup delay remains a challenge.

### SUMMARY OF THE INVENTION

A video receiving peer device, according to one embodiment of the invention, is adapted to receive a video signal from one or more of a video server and a serving peer device for concurrent or subsequent display. The video receiving peer device includes a memory portion adapted to store a leading sub clip (also known as a video prefix). The stored prefix allows rapid commencement of a video display and improved admissions performance.

Related applications are directed towards performance aware peer-to-peer video-on-demand service, and to admission control for such a service. These applications incorporate peer-to-peer downloading into the traditional client-server video-on-demand service model. In various embodiments, the peer-to-peer downloading carries the major data transfer load and significantly reduces the workload imposed on the server.

Video-on-demand service allows a user to select and watch video content over a network at a time selected by the user. The related application includes a segmented peer-to-peer video sharing model that enables content sharing in a video-on-demand setting. The performance issue is addressed by incorporating a performance aware peer-to-peer data downloading algorithm and server-assisted complementary streaming that collectively realize performance similar to the performance offered by the traditional client-server service model but supporting more users. In this system, the server devotes most of its resources to providing urgent data to meet the performance requirement and to streaming a video prefix to the receiving peer after the receiving peer is admitted to the system. The server's involvement in streaming the leading sub clips to the receiving peer consumes server bandwidth, however, and limits the number of receiving peers that can be admitted.

Surprising performance improvement is afforded by allowing each receiving peer to cache the video prefixes of one or more video programs. In various embodiments, a complete set of such prefixes are locally cached, making it possible to avoid leading sub clip streaming entirely. This significantly improves system scalability. More generally, the perceived performance at the receiving peer end is improved. The peer-to-peer downloading algorithm of the present invention is designed with the availability of cached video prefixes in mind.

The present invention is directed towards further improving the receiving peer's perceived video quality by timeshifting, reducing or eliminating leading sub clip streaming. According to various embodiments of the invention, the server has a number of tasks or services to perform including performing complementary streaming and uploading content to receiving peers in the peer-to-peer network. According to embodiments of the invention, video prefixes are transmitted from the server to receiving peer cache memories during periods of low network and/or server demand. Due to the limited bandwidth resources at the server and the server's responsibility to provide various services and perform various tasks, it is important to conduct admission control so that the receiving peers' perceived video quality meets user expectations. When cached prefixes are available, admission control parameters can be selected to allow additional video-on-demand receiving peers into the system.

In the present invention the method and apparatus for supporting admission control for a peer-to-peer video-on-demand service are designed to improve users' perceived video quality in a performance aware video-on-demand service environment were a cached video prefix is, or may be, available. The method and apparatus of the present invention monitor the current bandwidth usage and bandwidth usage history, and considers the availability of video prefixes, to determine if a request can be admitted into the video-on-demand system.

Accordingly, a method and apparatus for performing admission control in a peer-to-peer video-on-demand system are described, including determining if there is sufficient bandwidth to support a new request from a video playback device where a requisite video prefix is cached locally at the device, determining if there is sufficient bandwidth to admit the request without sacrificing quality of service for existing requests, accepting admission of the new request if both determining acts are positive and rejecting admission of the new request if either of the determining acts are negative. Also described is an apparatus for providing content to a video playback device in a peer-to-peer video-on-demand system including an admission control unit and a data engine component.

According to one embodiment of the invention, the availability of a pre-stored video prefix allows substantially immediate commencement of a requested video playback without allocating server bandwidth for streaming playback. By pre-storing a video prefix in the local cache memory, a delay between a user request and a corresponding commencement of playback is reduced or substantially eliminated without incurring the server and bandwidth costs associated with the streamed playback of the video prefix.

In one embodiment, the local cache memory includes a magnetic disk drive. In another embodiment, the local cache memory includes an optical disk drive. In still another embodiment of the invention, the local cache memory includes one or more of a dynamic RAM memory, a static RAM memory, a flash memory, a programmable read-only memory or another memory storage device.

It should be noted that a video playback device is any device capable of receiving and playing back video (stored or live) including but not limited to computers, laptops, personal digital assistants (PDAs) and mobile devices. A peer-to-peer network is not limited to a wired line network and may be a wireless or wired line network or a hybrid network employing both wired line and wireless connections.

Providing locally cached video prefixes significantly reduces video-on-demand server burden and allow allows improvements in scalability and quality of service. In addition, variations in network loading over time allow for the transfer of leading sub clips to local client caches from the server during intervals of relatively low network loading.

According to one embodiment of the invention, a peer-to-peer network server is responsible for three types of services: (i) uploading video prefixes for pre-caching into receiving peer memory devices (this pre-caching enables the receiving peers to start the playback immediately) (ii) uploading the video content of subsequent sub-clips to receiving peers through the peer-to-peer network by the server and (iii) serving complementary streaming of sub-clips to receiving peers when there is missing data in a sub-clip and the deadline of the sub-clip is reached.

### BRIEF DESCRIPTION OF THE DRAWINGS

The present invention is best understood from the following detailed description when read in conjunction with the accompanying drawings. The drawings include the following figures briefly described below where like-numbers on the figures represent similar elements:

FIG. 1 shows a portion of a video-on-demand system according to one embodiment of the invention;

FIG. 2 shows a further portion of a video-on-demand system according to one embodiment of the invention;

FIG. 3 shows a server architecture for a server device according to one embodiment of the invention;

FIG. 4 shows, in flow diagram form, an operative method according to one embodiment of the invention;

FIG. 5 shows a graphical representation of admission ratio for a video-on-demand system according to one embodiment of the invention;

FIG. 6 shows a graphical representation of average missing ratio for a video-on-demand system according to one embodiment of the invention; and

FIG. 7 shows a graphical illustration of server-side bandwidth requirements according to one embodiment of the invention.

### DETAILED DESCRIPTION

The following description presents the invention in terms of peer-to-peer video-on-demand systems. One of ordinary skill in the art will appreciate, however, that the embodiments presented, including a preferred embodiment, are exemplary of the invention, and are not meant to be limiting. Accordingly, it is understood that the invention may be applied in a variety of embodiments including, for example, peer-to-peer audio on-demand systems and other multimedia systems.

The present invention overcomes the drawbacks discussed above. In part, the invention surprisingly improves system performance by storing leading multimedia sub clips (such as audio and/or video leading sub clips) in a receiving peer device of a peer-to-peer system (a peer-to-peer client device) prior to a request for service. Because of this advance, a request for video-on-demand service can be accommodated promptly and with little or no immediate incremental server loading. In addition, because the storage of leading sub clips can take place at any time prior to replay of the leading sub clip, timeshifting of leading data transfers can allow optimization of network loading schedules.

The demand for video content on the internet has the temporal pattern in which the request rate at peak time could be tens or even hundreds of orders of magnitude larger than the request rate when the traffic volume is lowest. This kind of traffic pattern allows the server to push video prefixes to the peer-to-peer receiving peers (such as, for example, set-top boxes) when network traffic is light. For example, the server could push the prefix of each video in the media library to the set-top boxes in the daytime of weekdays, when few clients request video content. Further, one of skill in the art will appreciate that it is now possible to hold short prefixes for hundreds of movies on a receiving peer such as a set-top box without significantly increasing the cost of the set-top box. Network bandwidth now tends to be the bottleneck.

The foregoing benefits, among others, are found in a video-on-demand system that includes a receiving peer storage device for storage of a video prefix at a receiving peer device. The storage device allows rapid access to the video prefix after admission of a receiving peer request. In this way, the receiving peer device is able to begin presenting a requested video program to a user without waiting for delivery of the video prefix by, for example, streaming from a dedicated server device or from a serving peer device. This video prefix caching is advantageous in a video-on-demand system such as, for example, a system having quality of service aware admission control capability.

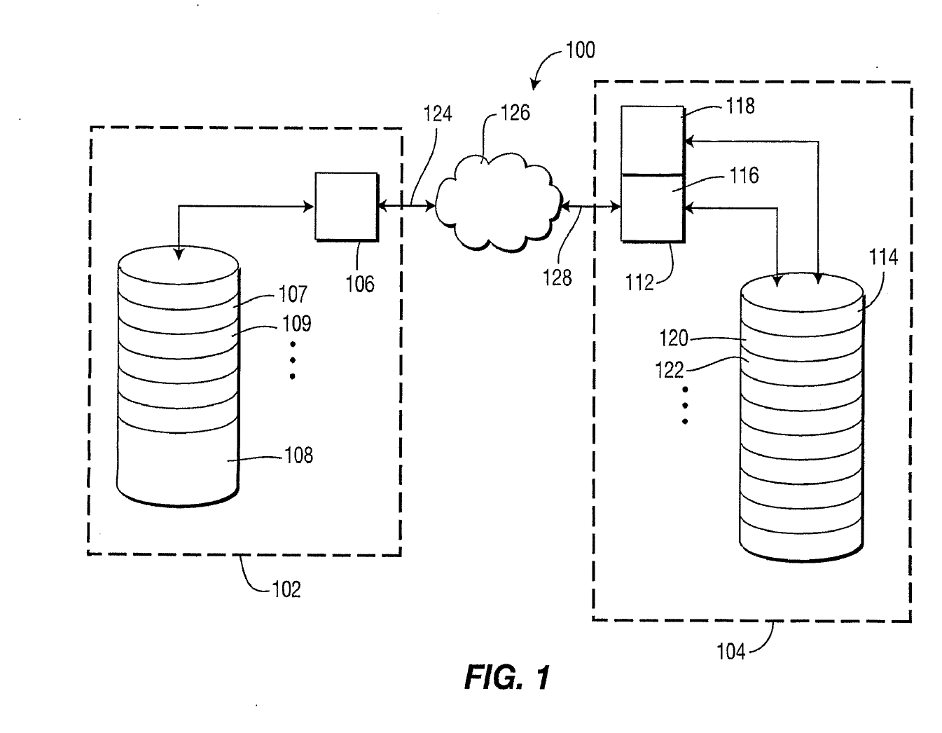

FIG. 1 shows a portion of a digital video-on-demand system 100 according to an exemplary embodiment of the invention. System 100 includes a server device 102 and a peer device 104. In the illustrated embodiment, the server device 102 includes a server control portion 106 and a server storage portion 108. The server storage portion is adapted to retrievably store data such as, for example, digital video program data. Generally, a plurality of video programs e.g., 107, 109 are stored in the server storage portion 108.

The peer device 104 includes a peer device control portion 112 and a peer device storage portion 114. In the illustrated embodiment, the peer device control portion 112 includes a communications portion 116 and a playback portion 118. One of skill in the art will appreciate that various other arrangements are possible within the scope of the invention as disclosed herewith.

The communication portion 116 is adapted to receive video program data, and to store that data in the peer device storage portion 114. The playback portion 118 is adapted to retrieve at least a portion of the stored data from the peer device storage portion 114 and produce a video program display as requested, for example, by a user. As will be described in further detail below, the peer device storage portion is adapted to store one or more leading sub clips 120, 122 corresponding to respective video programs that the user might request.

In various embodiments, the server storage portion 108 and/or the peer device storage portion 114 is implemented as a magnetic hard disk drive. One of ordinary skill in the art will appreciate that the choice of a disk drive as a storage device represents one of many possible choices. Alternative embodiments of the invention include a peer storage device implemented as FLASH memory, Erasable Programmable Read-Only Memory (EEPROM), Dynamic Random Access Memory (DRAM), Static Random Access Memory (SRAM), Magnetic RAM (MRAM), and Phase Change Random Access Memory (PRAM), among other alternatives.

The server device 102 includes a server network interface device 124 that is adapted to signalingly couple the server control portion 106 to a digital communication network 126 such as, for example, the Internet. The peer device 104 also includes a client network interface device 128 that is adapted to signalingly couple the client control portion 112 to the digital communication network 126. In this way, responsive for example to a user command, the peer device 104 can signal an admission request to the server device 102 and the server device 102 can convey an admission signal followed by video program data to the (now receiving) peer device 104.

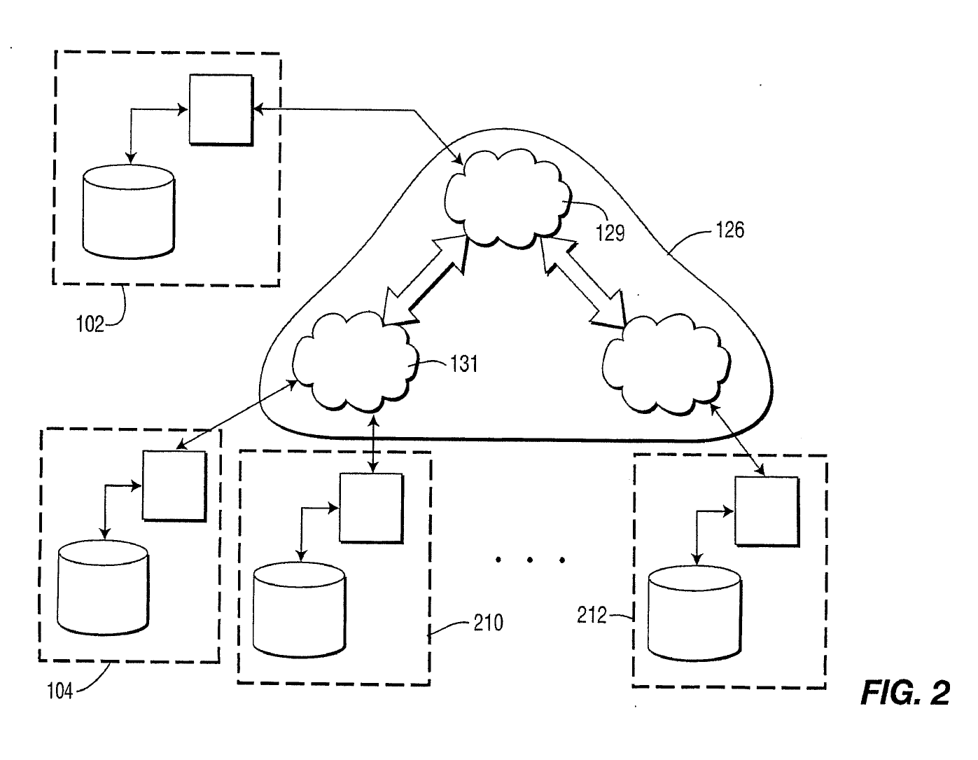

FIG. 2 shows the exemplary server device 102 and receiving peer device 104 of FIG. 1 in the context of a broader system. As shown, a plurality of further peer devices 210, 212 are signalingly coupled to the network 126. In a non-peer-to-peer embodiment, video data is sourced from a server device and received at a client device. In a peer-to-peer embodiment, peer devices e.g., 104, 210, 212 are implemented with a combination of receiving peer (or client) capability and sending peer (or server) capability. In this way, the system can take advantage of available upload bandwidth of the sending peer client devices to supplement the upload capability of the server. In addition, network bandwidth requirements can be distributed over various portions 129, 131 of the network 126. As described in a related application, this capability allows for increased scalability of video-on-demand systems.

In one embodiment of the invention, the video prefix data 120, 122 (as shown in FIG. 1) is received at receiving peer client device directly from the server device and stored at the local storage device 108. In a further embodiment of the invention, the video prefix data is received at the client device indirectly from the server device by way of, for example, an intervening sending peer device, e.g., 210, 212. In a still further embodiment of the invention, the video prefix data 120, 122 is received from the server device and/or the Intervening Peer Device during a comparatively low-load time interval when network loading is at a low level, as compared with maximum network loading.

In one embodiment of the invention, the complement of video prefixes stored on the local storage device e.g., 114 includes one video prefix for each of the video programs e.g., 107, 109 stored on the storage device 108 of the server device 102. In another embodiment of the invention, the complement of video prefixes stored on the local storage device 114 includes a plurality of video prefixes corresponding to a subset of the video programs stored on the storage device 108 of the server device 102. This subset of video programs may be selected based on the active selection of a particular user, or the observed viewing habits of such a user, or upon observed viewing habits of a broader population of users such as, the population at large, among other selection modes.

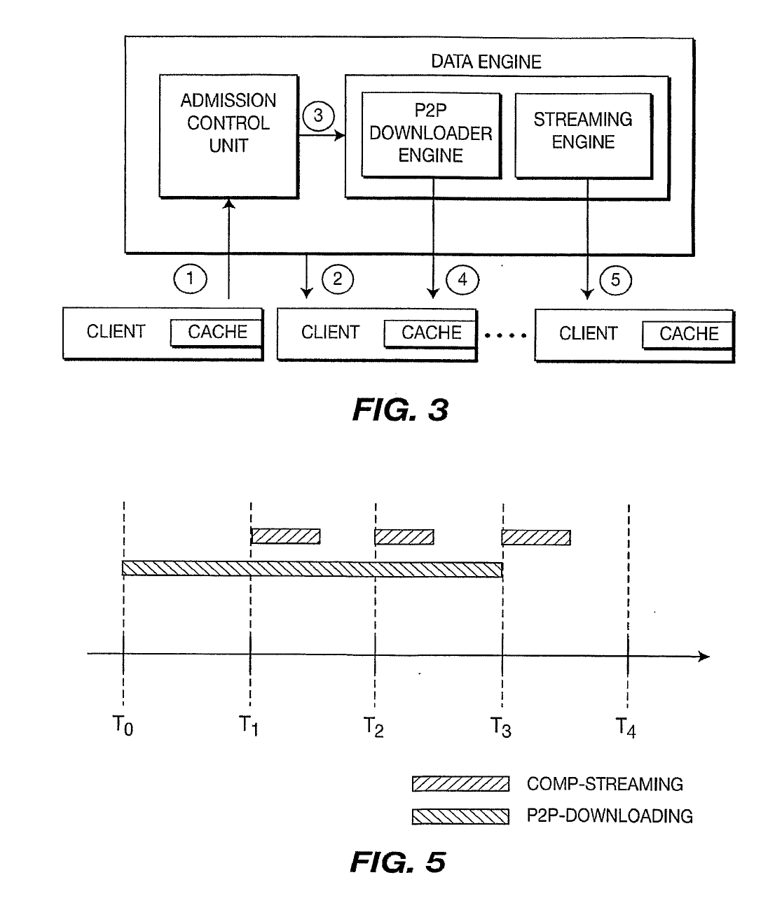

FIG. 3 shows, in block diagram form, an architecture of prefix-caching assisted performance aware peer-to-peer streaming server according to one embodiment of the invention. The server includes at data engine component with two sub-components. A first subcomponent is a streaming engine. A second subcomponent is a peer-to-peer downloader. The data engine and peer-to-peer downloader provide for complementary streaming service and peer-to-peer downloading service, respectively.

When a new admission request is received at the server, it is routed to the admission controller. Based on the outcome from the admission controller process, the server sends an admission decision back to the requesting receiving peer device. If the receiving peer device is admitted, the admission control unit informs the data engine component of this decision.

Upon receipt of an affirmative admission decision, a receiving peer can immediately begin playing a cached video prefix out of local storage, is available. If no cached video prefix is available, the server streams the requisite prefix to the receiving peer, according to one embodiment. Concurrently the data engine component begins uploading data for following sub-clips through peer-to-peer network. If required to meet data priority demands, the server can also provide complementary streaming of following sub-clips.

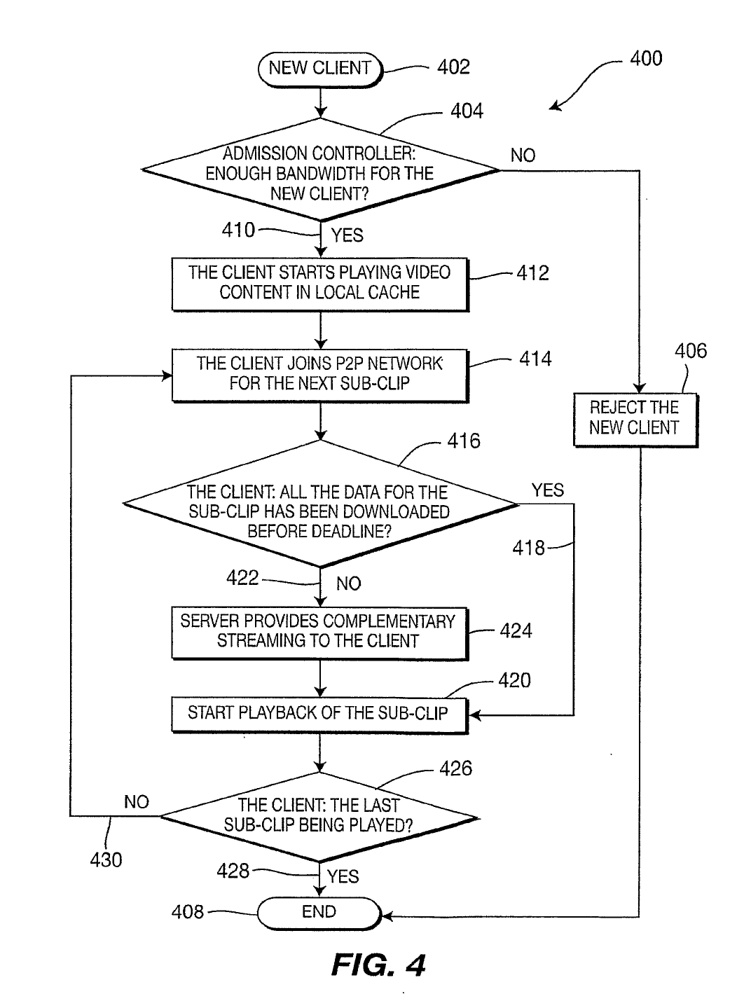

FIG. 4 shows, in flow diagram form, a portion of an operative method 400 of a digital video system according to one embodiment of the invention. In a first step 402 a new receiving peer device submits a request for video program data to an admission controller device. Upon receipt of the request, the admission controller device decides 404 whether or not enough resources (e.g., bandwidth) are available to allow admission of the new receiving peer (i.e., to supply the video program to the receiving peer). In the first alternative, insufficient resources are available for admission of the new receiving peer and admission of the new receiving peer is rejected 406. In this case, the illustrated portion of the operative method terminates 408. In a second alternative 400 and, sufficient resources are available for admission of the new receiving peer. A signal to this effect is sent to the receiving peer device and the receiving peer starts playing the video prefix data that was previously stored in a local cache 412. Thereafter, the receiving peer device joins a peer-to-peer network to receive subsequent video segments of the requested video program 414.

In one embodiment of the invention, the receiving peer device seeks a first subsequent video segment immediately after commencing playing of the video prefix data from the local cache. In another embodiment of the invention, the client device delays seeking the first subsequent video segment until the quantity of data stored in a local playback cache (i.e., remaining playback time) falls below an established threshold.

During the playback of the first subsequent video segment, and of every later subsequent video segment, a deadline is set for complete receipt of the following video segment. In a further step of the illustrated method 416, if the following video segment has been completely received by expiration of the deadline 418, playback of the following video segment commences 420. Otherwise 422, additional data to complete the further video sub clip is received from the server on a complementary streaming basis 424. Thereafter, playback of the following video segment commences 420.

A further step of the illustrated method 426 includes evaluation of whether the current video sub clip is or is not the last video sub clip in the video program. If the current video subject is not the last video subject in the video program 430 then the receiving peer device rejoins the peer-to-peer network 414 to receive the next video sub clip. If the current video subject is the last sub clip of the current video program 428, then the illustrated portion of the method terminates 408.

According to various embodiments, the admission control device is integral with the server device. The admission control device ascertains whether the server and/or serving peer combination is capable of providing the requested program of video data with an acceptable quality of service. Such an arrangement is known as quality of service (QoS) aware admission control.

With the prefix caching, the server in performance aware peer-to-peer streaming service is responsible for three types of services: (i) uploading video prefixes for pre-caching into receiving peer memory devices (this pre-caching enables the receiving peer is to start the playback immediately) (ii) uploading the video content of subsequent sub-clips to receiving peers through the peer-to-peer network by the server and (iii) serving complementary streaming of sub-clips to receiving peers when there is missing data in a sub-clip and the deadline of the sub-clip is reached.

BW is used to denote the total server bandwidth. BW_{comp-streaming} denotes the bandwidth used for complementary streaming; and BW_{p2pdownloading} denotes the bandwidth used for peer-to-peer downloading. The definitions of important symbols are included in Table 1.

TABLE 1
Definition of Important Symbols

| Symbol | Definition |
|---|---|
| BW | Total server bandwidth |
| BW_{comp-streaming} | Bandwidth usage for complementary streaming |
| BW_{p2pdownloading} | Bandwidth used for peer-to-peer data uploading |
| B̅W̅_{comp-streaming} | Average bandwidth usage for complementary |
| | streaming |
| B̅W̅_{p2pdownloading} | Average bandwidth usage for peer-to-peer |
| | downloading |
| σ | Standard deviation of aggregated complementary |
| | streaming bandwidth usage |
| N | Total number of users currently in the system |
| C | The number of sub-clips prefix cached |
| α | Weight used in updating the value of B̅W̅_{comp-streaming} |
| | and B̅W̅_{p2pdownloading} |
| R | Video play back rate |

FIG. 5 illustrates an example of server bandwidth usage to serve a single client when C=1. The video consists of four sub-clips and starts at time T₀. The content of first sub-clips is locally cached and could be played immediately. At the deadline of each following sub-clip, i.e, at time T1, T2, and T3, the complementary streaming is initiated at the playback rate to fill up the missing data. The peer-to-peer downloading starts from the beginning and ends at the deadline of the last sub-clip.

The complementary streaming bandwidth usage can be approximated by a Bernoulli random variable since complementary streaming rate is either r or zero. The admission controller keeps track of the amount of data that needs to be transmitted by complementary streaming for each sub-clip. This quantity is denoted by S_{comp-streaming}. The average complementary streaming data rate for this sub-clip is S_{comp-streaming}/T, where T is the sub-clip length. The admission controller maintains the average complimentary streaming rate information, B̅W̅_{comp-streaming}. The value of B̅W̅_{comp-streaming} is updated whenever a new average complementary streaming rate is available. Specifically,

B̅W̅_{comp-streaming}=α· B̅W̅_{comp-streaming}+(1−α)·(S_{comp-streaming}/T) (1)

The weight, α, decides how quickly the average complementary streaming bandwidth usage catches up with the current value. Experiments show that a value around 0.95 offers good performance results.

Turning now to estimate the variance of B̅W̅_{comp-streaming}. A Bernoulli distribution is used to approximate the complementary streaming bandwidth usage. The variance of B̅W̅_{comp-streaming} can be computed as follows:

Var( B̅W̅_{comp-streaming})=(1− B̅W̅_{comp-streaming})* B̅W̅_{comp-streaming} (2)

The server also keeps track of the amount of data that has been transmitted to the users through peer-to-peer network. The average server peer-to-peer uploading bandwidth, B̅W̅_{p2pdownloading} is update at the deadline of sub-clips. Denote by S_{p2pdownloading} the amount of data that is transferred to the user using peer-to-peer network during one sub-clip length, yields

B̅W̅_{p2pdownloading}=α· B̅W̅_{p2pdowdoading}+(1−α)·(S_{p2pdownloading}/T) (3)

With the statistics collected, the following formula is used to test if the request can be admitted:

N( B̅W̅_{comp-streaming}+βσ)+N· B̅W̅_{p2pdownloading}<BW (4)

where N is the number of users, σ is the standard deviation of aggregate complementary streaming bandwidth, and β is the standard deviation weight.

The aggregated complementary streaming bandwidth usage is the sum of N_{comp-streaming} Bernoulli random variables. According to the Central Limit Theorem, the sum of random variables can be approximated by a normal distribution and its standard deviation is governed by Equation (5).

$$σ = \sqrt{Var ( {\overline{BW}}_{comp - streaming} ) / {N}_{comp - streaming}} \qquad ( 5 )$$

In Equ (4), β is selected to be three to make sure that the required bandwidth is smaller than the available bandwidth with high probability. Thus the users' viewing quality will not degrade with the admission of new client.

FIG. 5 shows the bandwidth usage in a performance aware peer-to-peer video-on-demand streaming service environment with prefix caching from the point of view of the server. The server bandwidth used to precharge client cache memory with video prefixes is not shown, because this activity is conducted with otherwise idle bandwidth. For example, video prefixes are pushed to receiving peer cache devices during times of low network usage.

The advantages of the present invention include an improved admission ratio. The admission ratio is defined as the fraction of client requests that are admitted to receive VoD service; average missing fraction as the fraction of video content that misses the playback time, which indicates the users viewing quality; and normalized workload as the product of video length and request rate (i.e. average number of requests per video length).

In the experiments, the average uplink bandwidth of clients is larger than the playback rate. One video is simulated with the length of 3600 seconds, and the prefix cache size is about 3% of the whole video length on average.

FIG. 6 shows the trend of admission ratio as the workload increases. As can be seen, the PONDER with prefix caching could accommodate up to 360 requests per video-length with greater than 99% admission rate, which is three-folder performance gaining compared to the admission ratio of 120 requests per video-length from PONDER without prefix caching.

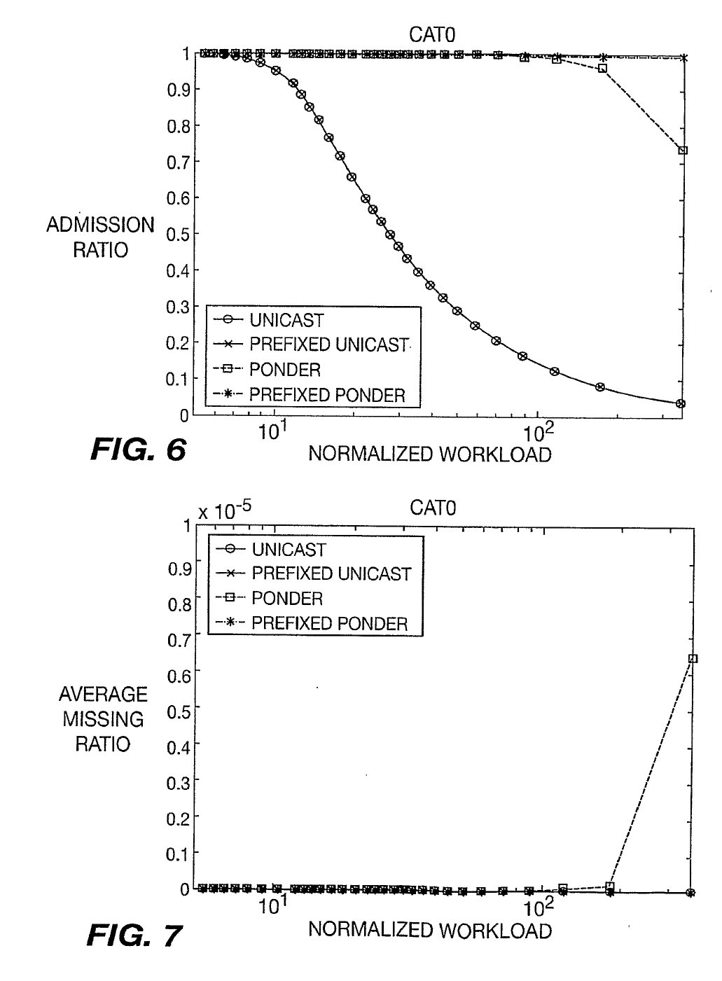

Along with the largely increased admission ratio (i.e. system scalability), prefix caching also brings better viewing quality similar to users than the no-prefix-caching peer-to-peer VoD. As shown in FIG. 7, even when the system reaches the point of 360 requests per video, the average missing fraction is still close to 0.

In the experiments where FIG. 6 and FIG. 7 are derived, the average uplink bandwidth of sending peers is larger than the playback rate. There is only one video with the length of 3600 seconds, and the prefix cache size is about 3% of the whole video length on average.

The fact that the increase of the storage space of 3% of the entire video library brings up system scalability by three folders clearly shows the effectiveness of prefix caching technique.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture.

In one embodiment, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

In various embodiments of the invention, a video prefix is received at a receiving peer device in response to a multicast of video prefix data from a server device or from a serving peer device. The video prefix received may be selected as a function of the receiving peer device, the serving peer device, or the server device based on a selection profile. For example, the selection profile may represent a viewing preference of a user associated with the receiving peer device. Viewing preference may be entered by the user, or automatically developed based upon a viewing history at, for example, the receiving peer device. In another embodiment of the invention, the selection profile may be based upon, for example, a viewing history of a select population of users or a global population of users. In still another embodiment, a receiving peer device receives all available video prefixes provided by a particular server device or serving peer device. In another embodiment, the video prefix is not multicast, but directed to the particular receiving peer.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A digital multimedia peer-to-peer device comprising:
a local cache memory adapted to store a multimedia prefix prior to receipt of an admission signal at the multimedia peer-to-peer device; and
a controller adapted to receive said admission signal and responsively commence playback of said multimedia prefix and thereafter receive multimedia program data related to said multimedia prefix, wherein receiving said admission control is conditional upon determining if there is sufficient bandwidth to support a new request for admission from a multimedia playback device where a requisite multimedia prefix is cached locally and determining if there is sufficient bandwidth to admit the request without sacrificing quality of service for existing admitted users.

2. The digital multimedia peer-to-peer device as defined in claim 1 wherein said local cache memory device includes a multimedia prefix, said multimedia prefix being one of a plurality of multimedia prefixes, said plurality of multimedia prefixes corresponding respectively to a plurality of multimedia programs stored on a server device.

3. The digital multimedia peer-to-peer device as defined in claim 1 wherein said local cache memory device is adapted to store said multimedia prefix during a period of low network usage.

4. The digital multimedia peer-to-peer device as defined in claim 1 wherein said local cache memory device comprises an electromechanical disk drive device.

5. The digital multimedia peer-to-peer device as defined in claim 1 wherein said local cache memory device comprises a semiconductor memory device.

6. The digital multimedia peer-to-peer device as defined in claim 1 wherein said digital multimedia peer-to-peer device is a first peer-to-peer device, wherein said first peer-to-peer device is adapted to act as a serving peer device, and wherein said controller is adapted to transmit said multimedia prefix to a second peer-to-peer device over a communications network, said second peer-to-peer device being adapted to act as a receiving peer device.

7. The digital multimedia peer-to-peer device as defined in claim 6 wherein said multimedia prefix is transmitted during a period of low network usage.

8. The digital multimedia peer-to-peer device as defined in claim 1 wherein said controller is adapted to send an admission request to an admission control device, said admission control device being adapted to consider a presence or absence of a pre-cached multimedia prefix at said multimedia peer-to-peer client device.

9. The digital multimedia peer-to-peer device as defined in claim 1 wherein said controller is adapted to receive a streamed multimedia prefix from a server if a locally cached multimedia prefix is unavailable at the multimedia peer-to-peer device.

10. A method of operating a multimedia-on-demand peer-to-peer device comprising:
requesting admission to a multimedia-on-demand system;
receiving admission to said multimedia-on-demand system;
commencing reproduction of a first portion of a multimedia program based on a multimedia prefix stored in a local cache; and
subsequently receiving a further multimedia sub clip from a communication network of said multimedia-on-demand system, wherein receiving admission is conditional upon determining if there is sufficient bandwidth to support a new request for admission from a multimedia playback device where a requisite multimedia prefix is cached locally and determining if there is sufficient bandwidth to admit the request without sacrificing quality of service for existing admitted users.

11. The method of operating a multimedia-on-demand peer-to-peer device as defined in claim 10 comprising:
storing said stored multimedia prefix in an electromechanical memory device.

12. The method of operating a multimedia-on-demand peer-to-peer device as defined in claim 10 comprising:
storing said stored multimedia prefix in a semiconductor memory device.

13. The method of operating a multimedia-on-demand peer-to-peer device as defined in claim 10 comprising:
storing said stored multimedia prefix in said local cache during a time interval of low network loading.

14. The method of operating a multimedia-on-demand peer-to-peer device as defined in claim 10 comprising:
storing said stored multimedia prefix in response to receipt of a digital multimedia multicast data from a server device.

15. The method of operating a multimedia-on-demand peer-to-peer device as defined in claim 10 comprising:
receiving said admission wherein said admission is based on a server's consideration of availability of said multimedia prefix being stored in said local cache.

16. The method of operating a multimedia-on-demand peer-to-peer device as defined in claim 10 further comprising reproducing said further multimedia sub clip of said multimedia program.

17. A multimedia device comprising:
a controller, said controller being adapted to be coupled to a communications network for peer-to-peer communications; and
a cache memory, said cache memory being coupled to said controller, said cache memory being adapted to store a multimedia prefix for playback, said playback to commence prior to receipt of further multimedia data related to said prefix from said network, said playback being conditional upon receiving an admission signal, wherein receiving said admission signal is conditional upon determining if there is sufficient bandwidth to support a new request for admission from a multimedia playback device where a requisite multimedia prefix is cached locally and determining if there is sufficient bandwidth to admit the request without sacrificing quality of service for existing admitted users.

18. The multimedia device as defined in claim 17 wherein said multimedia prefix comprises an audio prefix.
